(19) United States
(12) Patent Application Publication
(10) Pub. No.: US 2015/0196022 A1
(43) Pub. Date: Jul. 16, 2015

(54) ABSORBENT PAD HAVING THREE OR MORE MODULES TO ENHANCE PRESERVATION OF FLOWERS

(71) Applicant: Paper-Pak Industries, Laverne, CA (US)

(72) Inventors: Ronald Jensen, Chicago, IL (US); Sayandro Versteylen, Fontana, CA (US); Richard Beu, Yorba Linda, CA (US)

(21) Appl. No.: 14/593,629

(22) Filed: Jan. 9, 2015

Related U.S. Application Data
(60) Provisional application No. 61/925,725, filed on Jan. 10, 2014.

(51) Int. Cl. A01N 3/02; B32B 3/04; B32B 1/02; A01G 7/06

(52) U.S. Cl. CPC A01N 3/02; A01G 7/06; B32B 3/04; B32B 1/02; B32B 2307/726

(57) ABSTRACT

An absorbent pad is provided having three or more adjacent modules as a treatment system that modifies the atmosphere in a container to prolong life and the physical/sensory characteristics of cut flowers at all stages of storage and transport. Each module of the absorbent pad of the present disclosure is a discrete absorbent pad in itself that contains an active agent, such as a CO₂ generation system or a SO₂ generation system. A method is provided for pre-wetting the outer modules without wetting the inner module to increase the duration and effectiveness of the active agents in the absorbent pad.

### CROSS-REFERENCE TO RELATED APPLICATIONS

The present application claims priority of U.S. Provisional Patent Application Ser. No. 61/925,725, filed on Jan. 10, 2014, the contents of which are hereby incorporated by reference in their entirety.

### BACKGROUND OF THE DISCLOSURE

1. Field of the Disclosure

The present disclosure provides an absorbent pad having modules to enhance preservation of flowers. More specifically, the present disclosure provides an absorbent pad having three or more adjacent modules where each module is a discrete absorbent pad that contains an active agent, such as a CO₂ generation system or a SO₂ generation system. The modules are positioned sequentially to form an absorbent pad that modifies the atmosphere in a container to prolong life and enhance the physical/sensory characteristics of cut flowers at all stages of storage and transport.

2. Description of Related Art

Cut flowers are transported from flower growers around the world, frequently in South America, Europe, and Africa, to distribution centers in the U.S., Europe and Asia. The cut flowers are then further shipped to florists or other retail locations where they are sold to consumers. More than 65% of the cut flowers consumed in the United States at present are grown in the Andean countries. Colombia is the largest producer, followed by Ecuador, which produces primarily roses, and then Peru. African countries, such as Kenya, are another major producer of cut flowers, with the primary commercial outlet to Europe through the Netherlands. Two of the primary transit and distribution centers for cut flowers are Miami, Fla. (United States) and Amsterdam (Netherlands).

The cut flower market is intensely focused on the quality of the flower. A poor-quality flower generally cannot be sold, no matter how inexpensively the flower is priced.

The general process for transporting cut flowers is as follows: flowers are harvested from the ground by cutting. The cut flowers are taken to a collecting center and processed for transport. The cut flowers are treated by dipping their stems dipped in a solution that kills insects and other pests, which is required for importing cut flowers into the United States and Europe. The cut flowers are cleaned, dried, and bundled. The bundles of cut flowers are placed in a container for transport.

The containers of cut flowers are then chilled in a refrigerator to a temperature of approximately 34° F.-40° F. (1.1° C.-4.4° C.), which decreases the rate of respiration of the cut flowers. The refrigerated containers of cut flowers are then loaded on refrigerated trucks, and transported to an airport. It is believed that by the present disclosure the flowers could then be shipped to a seaport instead of an airport. The refrigerated containers are loaded into the cargo hold of an airplane or ship, and transported to a floral transit center, such as Miami (Florida), United States, or Amsterdam, Netherlands. Upon arrival in the floral transit center, the refrigerated containers of cut flowers are moved from the cargo holds of the airplane or ship to a refrigerated warehouse. The refrigerated containers of cut flowers are loaded onto refrigerated trucks or other delivery vehicles for transporting to florists, retail store (e.g., supermarket or convenience store), or to local warehouses for shipping to another retail location. Upon reaching the final retail destination, the cut flowers are removed from the refrigerated container, and placed in refrigerated display cases or on a retail floor for sale to consumers, who take the cut flowers home to display in a vase at room temperature. The cut flowers deteriorate rapidly after removal from a chilled environment.

Cut flowers typically remain in the container between about 5 to 7 days if shipped to a flower transit center in the U.S., but often longer if shipped to a transit center in Europe, adding even more time in the container before the cut flowers arrive at their destinations where they are distributed for sale to consumers. If the cut flowers are left at the floral transit center for even an extra day or two before final trans-shipment, there are considerable losses of flowers that must be thrown away as unsellable.

Still another threat to marketability and quality of cut flowers is Botrytis infection. Botrytis cinerea is one of about 50 species of Botrytis fungus that can infect cut flowers. Flowers are especially susceptible to Botrytis infection when they have splits, cuts and abrasions when the flowers are hand-picked or handled by machinery. Damage can also be caused by insects and even wind. Any damaged area of a cut flower can serve as entry sites for microorganisms, such as B. cinerea.

Infection of cut flowers with Botrytis is sometimes called gray mold because it produces a crop of gray, fuzzy spores on the surface of infected plant tissues. The fungus grows on dead or dying plant tissue, whether in the field, packing shed, cooler, or during shipping. Flower petals provide an excellent food source for the production of Botrytis spores. Botrytis often appears first as a water-soaked spot or lesion on the leaf and flower buds. As the lesions coalesce, the petals turn brown and wither, and the infection can spread to flower stems. Botrytis infections can cause rapid deterioration of a cut flower during shipping, and, in some instances, loss of the entire cut flower. This can destroy the marketability and desirable qualities of the flowers. Rose, peony, geranium, and poinsettia can be particularly susceptible to Botrytis infection.

The lifespan and appearance of cut flowers can also be affected by the effects of ethylene, C₂H₄, a naturally-occurring hydrocarbon gas that is produced by flowers as they age. Ethylene has a “senescence effect” (also called an “aging effect”) on many species of cut flowers, as well as on other plants and fruits. The effects of ethylene on cut flowers are usually deleterious to the lifespan of the cut flower and its appearance. Ethylene can bind to ethylene receptors in the cut flower to cause early senescence (i.e., a shorter flower lifespan), rapid loss of petals and leaves, (early) induction of flowering, loss of chlorophyll, epinasty (downward-bending) of leaves and stems, and dormancy, any of which can result in a loss of value of the cut flower. Ethylene receptors are continually generated throughout the life of the flower. In addition, exposure to external ethylene in the environment (such as automobile exhaust, propane heater exhaust, wood smoke, and even cigarette smoke) can initiate internal ethylene production in some floral species.

Another economic loss due to the short lifespan of cut flowers occurs because flower growers, distributors and retailers are often forced to stockpile flowers during and before periods of extremely high demand, such as Valentine's Day. Deterioration in flower quality during storage and transport results in wastage and a large economic loss during times of maximum demand and production. Also, oversupply of flowers during these peak times can result in large quantities of unsold flowers that have to be destroyed the day after the holiday, since there presently are no practical methods to preserve cut flowers a few additional days for later sale.

### SUMMARY OF THE DISCLOSURE

The present disclosure provides an absorbent pad having three or more modules connected sequentially as a treatment system that modifies the atmosphere in a container to prolong life and enhance the physical/sensory characteristics of cut flowers at all stages of storage and transport.

The present disclosure also provides that each module of the absorbent pad of the present disclosure is a discrete absorbent module or pad in itself that contains an active agent, such as, for example, a CO₂ generation system or a SO₂ generation system.

The present disclosure further provides that the absorbent pad has three or more modules positioned next to each other and connected along their adjoining edges to form the absorbent pad of the present disclosure. Preferably, the three or more modules are connected in a straight line.

The present disclosure still further provides each module is kept separate from another so that the active agent in the pocket of each module is kept separate from the active agent(s) in the other modules in the absorbent pad.

The present disclosure yet further provides that each module has a discrete pad architecture so that the rate of release and order of release of the active agents are regulated, in part, by the architectural structure of each module, its placement in the absorbent pad, the layers and type of absorbent material used, and the stoichiometry and choice of reactants for the active agent(s).

The present disclosure also provides that each module of the absorbent pad has an absorbent body made of layers of an absorbent or superabsorbent material.

An absorbent pad of the present disclosure can be placed in each separate container in which cut flowers are packaged, providing each container with its own replenishable source of CO₂ and SO₂ (or other active).

The absorbent pad of the present disclosure can be positioned in the container directly below, or directly above, the cut flowers to provide absorbency, active agents, and protective cushioning that further enhances the quality and appearance of the cut flowers.

The present disclosure further provides a method of manufacturing of an absorbent pad having three or more modules.

The present disclosure still further provides a method of pre-wetting the outer modules without wetting the inner module to prevent early activation of the active agent in the inner module. Pre-wetting the outer modules without wetting the inner module can increase the duration and effectiveness of the active agent in the absorbent pad.

The present disclosure yet further provides a method of using the absorbent pad having three or more modules of the present disclosure to prolong the life and enhance the physical and sensory characteristics of cut flowers during storage and transport.

### BRIEF DESCRIPTION OF THE DRAWINGS

FIG. 1 is a perspective view of an exemplary embodiment of an absorbent pad of the present disclosure placed on the bottom of a container for shipping of flowers.

FIG. 2 is a perspective view illustrating the absorbent pad in FIG. 1, showing three modules connected together in which each module is an absorbent pad in itself, where the first and third (outer) modules each have a CO₂ generating system, and the second (inner) module has a SO₂ generating system.

FIG. 3 is a perspective view illustrating the three modules immediately before being connected together along two seams to form the exemplary embodiment of the absorbent pad in FIG. 2.

FIG. 4 is a right side view showing a close-up of the overlapping sealed edges of the second (inner) module having a SO₂ generating system and the adjacent third (outer) module having a CO₂ generating system, before the overlapping areas are connected.

FIG. 5 is a perspective view of an exemplary embodiment of the absorbent pad in FIG. 1, in which the three modules are connected along their adjoining edges by a tape layer that runs the entire length of the two seams therebetween.

FIG. 6 is a perspective view of an embodiment of the first and third (outer) modules of the absorbent pad in FIG. 1 that contains a CO₂ generation system.

FIG. 7 is a cross-section view along axis A-A of the embodiment of an exemplary embodiment of the outer module in FIG. 6 with details of the layers of the module.

FIG. 8 is an illustration of another exemplary embodiment of the outer module in FIG. 6, showing the relation of the layers of the module.

FIG. 9 is a perspective view of an embodiment of the second (inner) module of the absorbent pad in FIG. 1 that contains a SO₂ generation system.

FIG. 10 is a cross-section view along axis B-B of the embodiment of an exemplary embodiment of the outer module in FIG. 9 with details of the layers of the module.

FIG. 11 is an illustration of another exemplary embodiment of the outer module in FIG. 9, showing the relation of the layers of the module.

FIG. 12A is a graph depicting a test of SO₂ concentrations measured over a period of time for a sample of sodium metabisulfite (Na₂S₂O₅) placed in an open environment.

FIG. 12B is a graph depicting the % Relative Humidity for each day of the test in FIG. 12A.

FIG. 13 is a graph depicting an “open system” test of SO₂ concentrations measured over a period of time comparing two experimental (PPI) absorbent pads with a control pad having a cell of two pockets that were taken apart and tested individually, where the two experimental absorbent pads are made of different materials and contain the same amounts of Na₂S₂O₅ as one or the other of the two pockets of the cell in the control pad.

FIG. 14 is a graph depicting a “closed system” test of SO₂ concentrations measured over a period of time for a control pad having a cell of two pockets, comparing the amount of SO₂ gas generated by the full cell with the amounts of SO₂ gas generated by each of the two pockets.

FIG. 15 is a graph of the results of a test of an absorbent pad having a SO₂-generating system in a box depicting SO₂ concentrations measured over a period of time inside a container for one-half of a control pad, and one-half of two experimental absorbent pads that are made of different materials, that each contain 3.5 g of Na₂S₂O₅.

### DETAILED DESCRIPTION OF THE DISCLOSURE

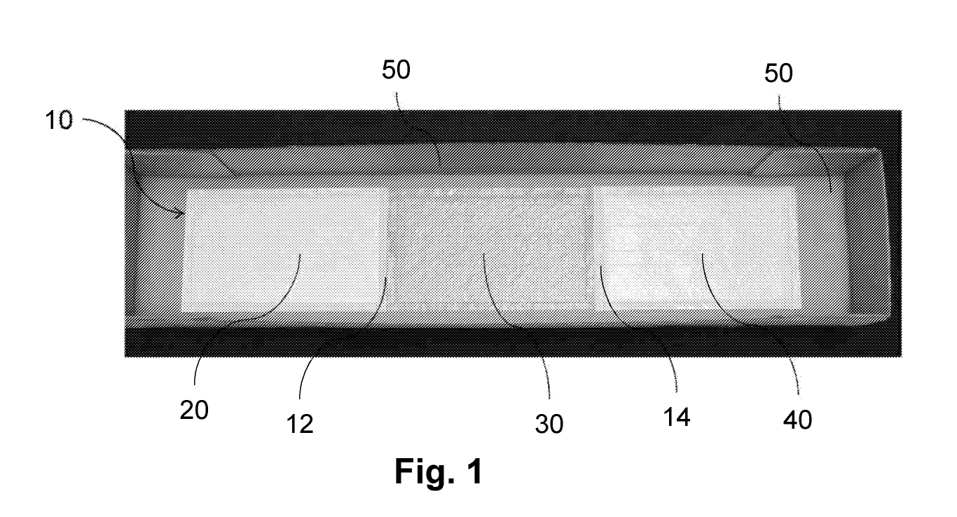

Referring to the drawings, and in particular, FIGS. 1 to 3, there is provided an exemplary embodiment of an absorbent pad of the present disclosure generally represented by reference number 10. Absorbent pad 10 has three or more modules, including at least two outer modules 20, 40 connected to an inner module 30. Each outer module 20, 40 and inner module 30 is a discrete absorbent pad itself.

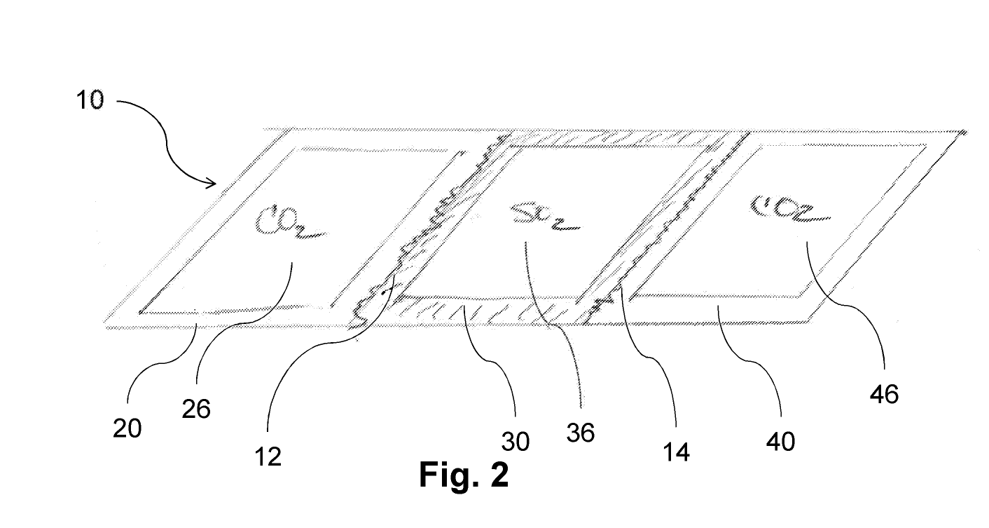

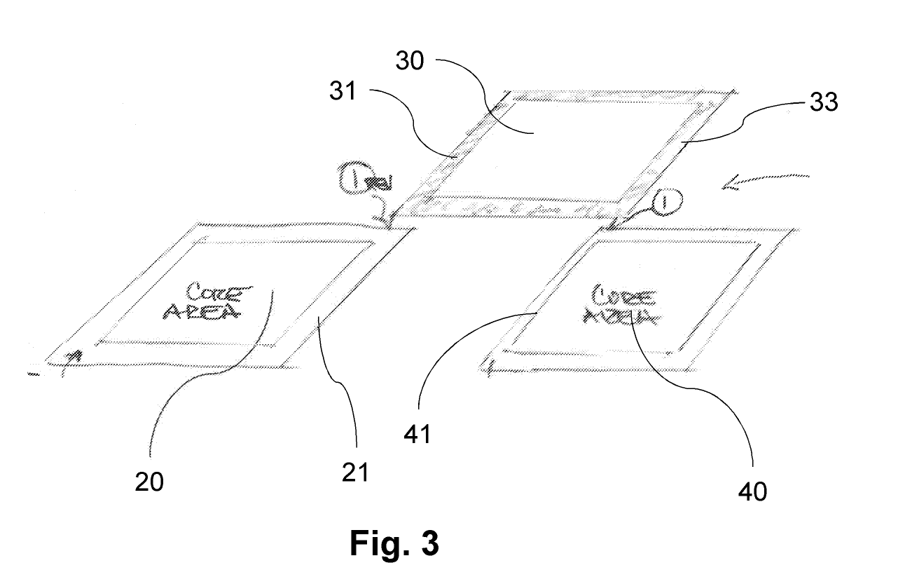

In the exemplary embodiment in FIGS. 2 and 3, absorbent pad 10 has a first outer module 20 connected to a first edge 31 of inner module 30 along a first seam 12. Inner module 30 has a second edge 33 that is opposite of first edge 31. Inner module 30 is connected to a second outer module 40 at second edge 33 along a second seam 14. In this embodiment, first outer module 20 is identical in pad architecture and its active agents to second outer module 40.

A “module” which is called a “segment” or “compartment” interchangeably in this application without a change in meaning, represents a discrete portion or a discrete absorbent pad that is joined along an edge with another module to form part or all of absorbent pad 10. In certain embodiments below, the modules are adjacent pads that are inside one larger outer shell (or chassis).

In the embodiments in FIGS. 1 through 5, absorbent pad 10 contains an absorbent body, which will be described below, inside each module. For example, first outer module 20 contains an absorbent body 26, inner module 30 contains an absorbent body 36, and second outer module 40 contains an absorbent body 46. In these embodiments, the absorbent bodies in adjacent modules (for example, absorbent body 26 and absorbent body 36) do not directly contact each other, and are separated by the sealed edge of the respective modules, even after the modules are connected to form absorbent pad 10. The active agent(s) contained in each module, are in the absorbent body of each module, so that each absorbent body acts as a separate pocket. Thus, the active agent in any module does not have direct contact with the active agent in any other module(s) that form absorbent pad 10.

In an alternative embodiment, the absorbent body can extend across seams 12 and/or 14. A stitchline (not shown) can separate the first outer module 20 and second outer module 40 and, thus absorbent body 26 from absorbent body 46, respectively.

In an alternative embodiment, absorbent pad 10 can have a module that does not have an absorbent body therein, to act as a spacer between modules, or as an endpiece used as a handhold by the growers or to secure the absorbent pad to the container.

FIG. 1 shows an embodiment in which absorbent pad 10 is placed flat on the bottom surface of a container 50 before cut flowers (not shown) are placed in container 50. Outer module 20, inner module 30, and outer module 40 each contain an active agent that modifies the atmosphere in the container, thereby prolonging life and enhancing the physical and sensory characteristics of the cut flowers.

The sequence of modules used in absorbent pad 10 can be selected to meet the requirements of the species of cut flowers, and the expected duration of shipment. FIGS. 1 and 2 illustrate a preferred embodiment of absorbent pad 10 in which the sequence of modules, as represented by the primary active agent generated by each module, is “CO₂/SO₂/CO₂”; i.e., in sequence from left to right, a first outer module 20 having a CO₂ generating system, connected to an inner module 30 having a SO₂ generating system, which is connected to a second outer module 40 having a CO₂ generating system.

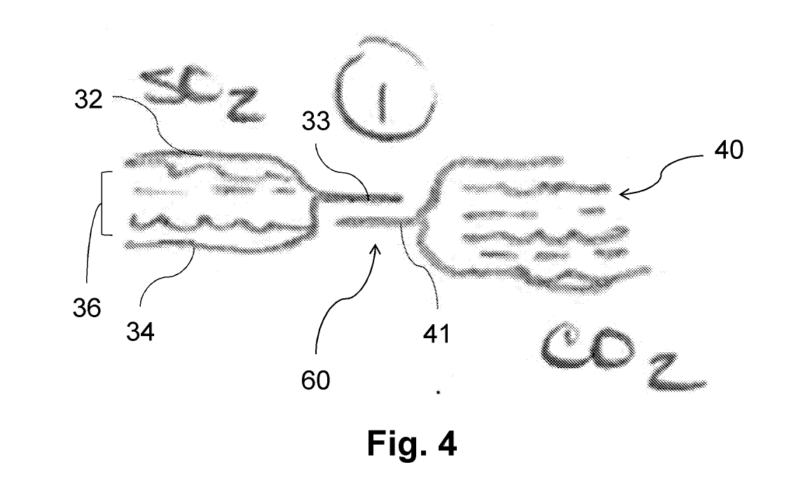

FIGS. 3 and 4 show how the individual modules are connected to each other to form absorbent pad 10. FIG. 3 shows that inner module 30 is placed between first outer module 20 and second outer module 40 so that part or all of first edge 31 overlaps part or all of an adjacent edge 21 of outer module 20 (not shown). Also, as shown in FIG. 4, a part or all of second edge 33 overlaps a part or all of adjacent edge 41 of outer module 40 to form an overlap area 60. The modules 20, 30, 40 are connected at each overlap area, either permanently or reversibly. Techniques to connect adjacent modules include, but are not limited to, ultrasonic bonding, thermal bonding, mechanical bonding (stitching), sewing, adhesive or other bonding, tape, and any combinations thereof.

The overlap area between modules can be formed by having second edge 33 of inner module 30 extend over adjacent edge 41 of outer module 40 to form overlap area 60, as shown in FIG. 4. Alternatively, second edge 33 of inner module 30 can extend under adjacent edge 41 of second outer module 40 to form overlap area 60.

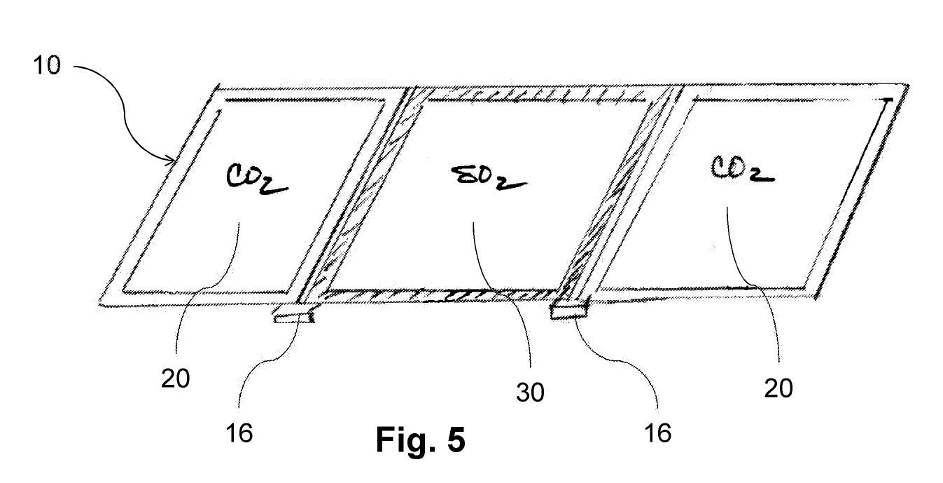

FIG. 5 illustrates an exemplary embodiment of absorbent pad 10 in which a tape 16 is used to connect outer module 20 to inner module 30 at the overlap area to form seam 12 (shown in FIG. 3). Tape 16 is also used to connect outer module 40 to inner module 30 at overlap area 60 to form seam 14. Tape 16 can extend along a part, or all, of seam 12 and seam 14 to reversibly or permanently connect the three modules 20, 30 40 that form absorbent pad 10.

When cut flowers are placed in container 50 shown in FIG. 1, the flowers can be divided into two or more groups that are oriented in opposite directions for more efficient packing, and to protect the flower petals and buds inside the container. For example, some of the cut flowers can be oriented so that half of the petals are at the top of container 50, and the remaining half of the flowers can be oriented to have the petals at the opposite end (i.e., the foot of the container 50).

Thus, the exemplary embodiment of absorbent pad 10 shown in FIG. 1 is structured so that either outer module 20 or outer module 40 is positioned directly beneath the petals for all cut flowers in container 50, even if the flowers are packaged in opposite directions for the reasons above. Absorbent pad 10 can be a shaped pad that fits the shape of a specific box type or container 50 used for storage and/or transport of cut flowers.

FIGS. 1 through 5 provide an exemplary embodiment of absorbent pad 10 having three modules. In alternative embodiments, absorbent pad 10 can further include additional modules, each additional module being connected sequentially to one of the ends of the absorbent pad. Specifically, in these embodiments, absorbent pad 10 can have four modules, five modules, six modules, or seven or more modules that are connected sequentially to one of the free ends and/or to one of the side edges of absorbent pad 10. Preferably, there are an odd number of modules; i.e., 3 modules, 5 modules, or 7 modules. The overall footprint of absorbent pad 10 can be a straight line of modules, as in FIGS. 1 through 5, or can be other geometries, such as a cross-shape. The pad architecture (including the active agent) of each of the fourth, fifth, sixth and seventh modules can be the same as outer module 20 or inner module 30, described below, or, alternatively, can be a module having no absorbent body therein that acts as a spacer between absorbent modules.

In an alternative embodiment, one or more of the modules can be inside of a larger, single chassis (also called an “outer shell” in this application without a change in meaning) that is absorbent pad 10. Absorbent pad 10 can have a pad architecture that keeps the “dry” portions of the absorbent pad dry, while directing the water to travel to other portions in the absorbent pad.

The type and amount of an active agent present in the additional module(s) can be selected based on the particular species of flower, and the requirements for lifespan of the particular species of flower. For example, an additional (fourth) module can be added to absorbent pad 10 that is shielded from activation at the time of packing, to serve as a reservoir of active agent that can be exploited by activating later during transport of the flowers to provide a delayed release or delayed “burst” of the active agent in the container trans-shipment.

The outer modules of absorbent pad 10 can be “wetted” by spraying water in or on one or more modules of absorbent pad 10 before the absorbent pad is placed in the container. Alternatively, the outer modules 20, 40 of absorbent pad 10 of FIG. 1 can be wetted after absorbent pad 10 is already placed in container 50.

Absorbent pad 10 can wet outer modules 20 and 40 by a specialized device or machine (not shown) that sprays or douses both outer modules without substantially wetting inner module 30. By wetting both ends at the same time, the operator only needs to handle the absorbent pad once. About 10-15% of the total absorbent body is wetted by this step.

Wetting the outer modules containing the components of a CO₂-generating system activates the release of CO₂ in the container. However, the module containing an SO₂ generating system is preferably not pre-wetted, since pre-wetting can change the kinetics of the reaction that generates SO₂, leading to a different, lower concentration of SO₂ being generated in the container, and/or cause the SO₂ generating system to be expended and consumed prematurely.

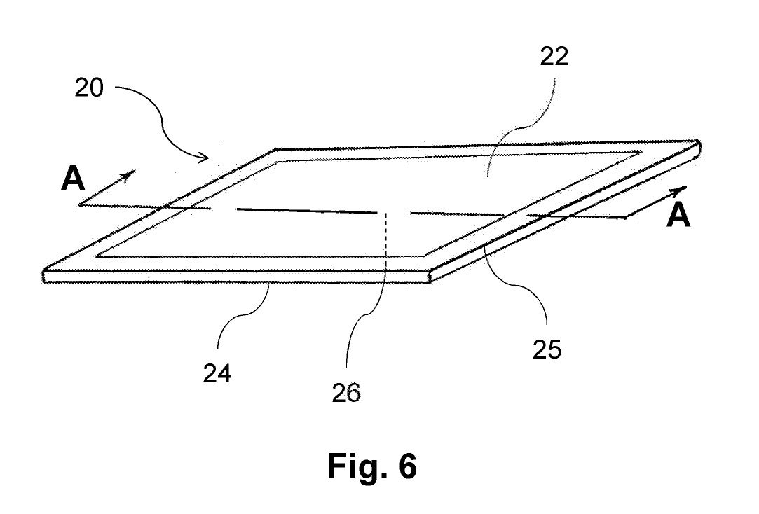

FIGS. 6 through 8 illustrate an exemplary embodiment of outer module 20.

Outer module 20 is a discrete absorbent pad in itself, and is connected to other modules to form absorbent pad 10.

All disclosures describing the pad architecture (including the active agents) of first outer module 20 also apply to second outer module 40 in a three-module embodiment.

Outer module 20 has a top layer 22, and a bottom layer 24 opposite top layer 22. Between top layer 22 and bottom layer 24 is an absorbent body 26 made of one or more layers of an absorbent and/or superabsorbent material. Top layer 22 and bottom layer 24 directly contact each other and are sealed at edges 25, thus to seal outer module 20 and enclose absorbent body 26. If present in outer module 20, a superabsorbent layer 29 is positioned between top layer 22 and bottom layer 24.

In an alternative embodiment, outer module 20 can have one or more of edges 25 that are left unsealed to form an open cell pad.

Top layer 22 can contact the stems and petals of the cut flowers. Top layer 22 can be a liquid-permeable material. In a preferred embodiment, top layer 22 is a nonwoven material. Examples of nonwoven materials for top layer 22 include, but are not limited to, polyolefin, polyester, and polyamide. Preferably, the nonwoven is polyethylene, polypropylene, polyester, or any combinations thereof. In another preferred embodiment, top layer 22 is made of spunbonded polypropylene. Top layer 22 can also be a hydrophilic nonwoven material, or treated with a surfactant or other hydrophilic material, to permit strikethrough of water to be absorbed by absorbent body 26. Alternatively, top layer 22 can be made of coffee filter tissue (CFT). The CFT can be a 16.5-pound white crepe paper that is about 99.5% softwood pulp, where “softwood pulp” means a pure virgin wood pulp that has never been processed. The softwood pulp can be bleached or unbleached. CFT can also contain about 0.5% of a wet-strength resin to give strength to the cellulosic fibers of the CFT when wet. An example of a wet-strength resin includes, but is not limited to, polyamide-epichlorohydrin (PAE) resin film that is polyethylene, polypropylene, polyester, or any combinations thereof.

Bottom layer 24 is generally positioned on the side farthest from the cut flowers in container 50. Bottom layer 24 can be a liquid-impermeable material. In an exemplary embodiment, bottom layer 24 is a film that is polyethylene, polypropylene, polyester, or any combinations thereof. In a preferred embodiment, bottom layer 24 is a blown polyethylene film. The blown polyethylene film can have a thickness of about 0.65 mil. In another embodiment, bottom layer 24 is a nonwoven that is a hydrophobic material that is partly or entirely impermeable to water. In yet another exemplary embodiment, bottom layer 24 is made of coffee filter tissue (CFT).

Outer module 20 is preferably sealed around its periphery at edges 25. The sealed portion is about a half-inch (0.5″) (1.3 cm) around each edge 25. However, the amount of edge 25 that is sealed can vary in size to be more or less than 0.5″ (1.3 cm).

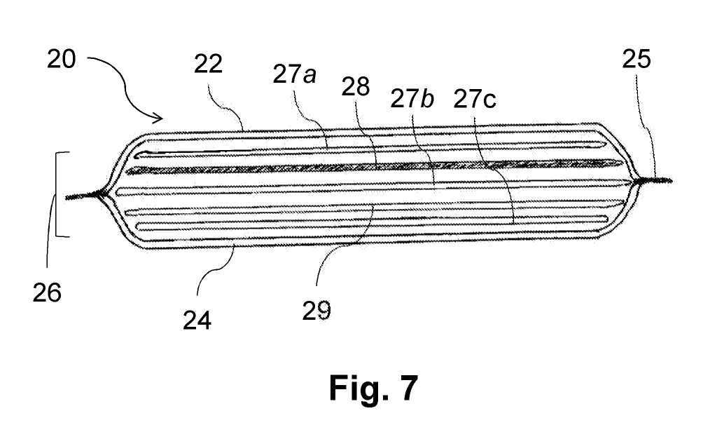

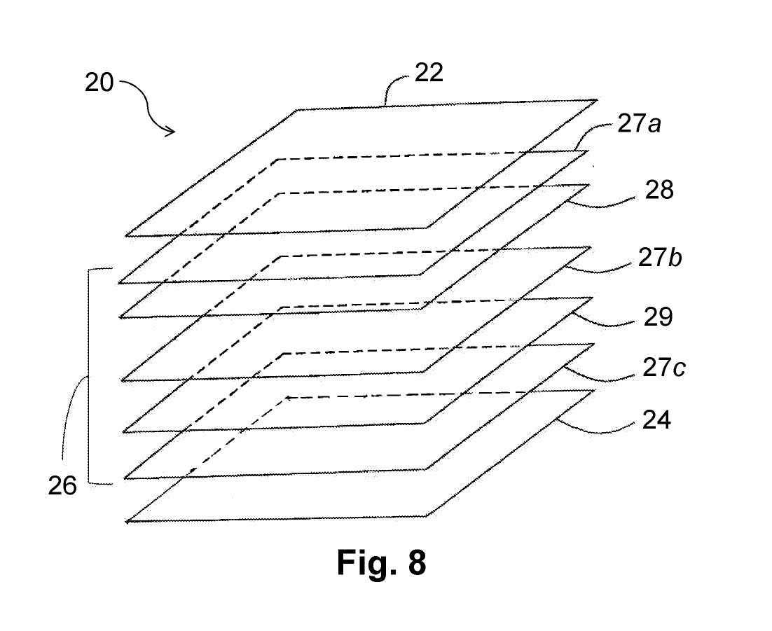

Absorbent body 26 is made of one or more layers of an absorbent material and/or a superabsorbent material. Absorbent body 26 absorbs liquids that are sprayed or otherwise added to outer module 20, and/or condensation that forms in the container during storage or transport, especially if the flowers are cooled. Absorbent body 26 is preferably made of an absorbent material that is one or more layers of tissue 27 (tissue 27 means either one or all layers of tissue, each separate layer being shown in FIGS. 7 and 8 as 27a to 27c). Each tissue layer 27 is a sheet of cellulose tissue, and can itself be formed of one or more individual tissues that are joined together to form the tissue layer. In a preferred embodiment, one or more of tissue layers 27 is a layer of crepe tissue. The number of tissue layers 27, as well their arrangement in the pad architecture of outer module 20, can vary to regulate the absorption for the outer module, as well as to regulate activation of any active agents therein. Besides tissue, the absorbent material can also be fluff pulp, cellulosic material, binding fiber, airlaid, nonwoven, woven, polymer, absorbent gels, compressed composite with short or microfiber materials, thermoplastic polymer fibers, cellulose powders, or any combinations thereof.

FIG. 7 is an exemplary embodiment of outer module 20 having top layer 22 that is a polyethylene film, and bottom layer 24 that is a nonwoven. In this embodiment, absorbent body 26 has three tissue layers 27a to 27c between top layer 22 and bottom layer 24. One tissue layer 27a is directly adjacent to top layer 22. Another tissue layer 27c is directly adjacent to bottom layer 24. Tissue layers 27b and 27c are directly above and directly below superabsorbent layer 29, respectively. An active agent 28, which is a CO₂ generation system in this embodiment, is positioned between tissue layer 27a and tissue layer 27b.

FIG. 8 is an illustration of another exemplary embodiment of outer module 20, showing top layer 22, bottom layer 24, and edges 25 around the periphery of outer module 20 where top layer 22 and bottom layer 24 are joined and sealed to enclose absorbent body 26 as better shown in FIG. 7. In this embodiment, absorbent body 26 has three tissue layers 27a to 27c, and a superabsorbent layer 29. Active agent 28, which is a CO₂ generation system in this embodiment, is positioned between tissue layer 27a and tissue layer 27b.

Tissue layers 27 have the ability to wick water and moisture horizontally and vertically through outer module 20, and thereby enhance migration of water throughout the entire outer module. As the water and/or moisture is distributed horizontally along the plane of an individual tissue layer (for example, along the horizontal plane of tissue layer 27b), the active agents contacting the water in that particular tissue layer are activated. Vertical migration of water and moisture also can carry one active component to react with another active agent that is positioned on a different level of the pad architecture. In this way, the rate and duration of activity of the active agent can be controlled and prolonged by selecting the type and thickness of each layer to control vertical migration, by the stoichiometry and amount of the active agents, and by placement of active agents in different portions of outer module 20.

Tissue layers 27 further provide the advantage of uniform distribution, end-to-end, of absorbed water or other liquids throughout outer module 20. For example, tissue layer 27a made of cellulose has cross-linked fibers that distribute absorbed water horizontally across the plane of tissue layer 27, fiber-to-fiber, from one end of absorbent body 26 to its opposite end, as well as widthwise from one edge to its opposite edge. In addition, where a second tissue layer 27b and a third tissue layer 27c are adjacent to first tissue layer 27a, any absorbed water will also distribute vertically, from fiber-to-fiber, from the tissue fibers in the first tissue layer 27a to second tissue layer 27b, and thence to third tissue layer 27c, and so on, including to superabsorbent layer 29. If sufficient water is absorbed, this horizontal distribution and vertical distribution allow absorbent body 26 of outer module 20 to be uniformly “wetted” with absorbed water that is available to activate one or more active agents in the pad architecture, as well as to serve as a hydration source that can enhance the physical and sensory characteristics of the cut flowers. Thus, tissue layers 27 allow absorbed water to be distributed three-dimensionally throughout outer module 20. This is an advantage over fluff absorbent material, which forms into “clumps” of fluff having spaces therebetween, and which cannot distribute water or moisture uniformly throughout outer module 20 because of spaces where there is little or no fluff material. An exemplary embodiment of outer module 20 having one or more tissue layers 27 is 15% lighter, yet 17% more absorbent, than a comparably-sized pad that uses cellulosic fluff material for absorbency.

Outer module 20 can also include a laminate (not shown) positioned between top layer 22 and bottom layer 24. When present, the laminate is preferably a part of absorbent body 26, along with tissue layers 27 and/or other absorbent material. Alternatively, the laminate can be the entire absorbent body 26. A laminate can be made of one or more plies of a cellulosic material, an adhesive (such as glue) or binder, and preferably includes an active agent. In an exemplary embodiment, a laminate that is 3.0 grams per square inch (GSI) in an absorbent body that is 3 inches by 5 inches can provide about 45 grams of absorbency to outer module 20.

Superabsorbent layer 29 is a thin superabsorbent material that can absorb and retain water. Examples of a superabsorbent material includes, but are not limited to, polyacrylate or carboxymethyl starch (CMS), superabsorbent polymer (SAP), compressed SAP, composite of SAP granules adhered with binder or plasticizer, airlaid with SAP, or a starch-based superabsorbent material, such as BioSAP™ (Archer-Daniels Midland, Decatur, Ill.), which is biodegradable and compostable, and a renewable resource.

In the embodiment of FIG. 7, superabsorbent layer 29 is positioned below tissue layers 27a and 27b, and above tissue layer 27c. Similarly, in the embodiment of FIG. 8, superabsorbent layer 29 is positioned below tissue layers 27a and 27b, and above tissue layer 27c. An advantage to positioning superabsorbent layer 29 near to, or even adjacent to, water-impermeable bottom layer 24 protects the water absorbed in superabsorbent layer 29 from direct contact with the flowers, and allows superabsorbent layer 29 to be a reservoir that “holds” the water so the water does not flow away, and can gradually hydrate the cut flowers during transport. As tissue layer 27a gradually relinquishes its water to stems and petals through top layer 22, tissue layer 27a then pulls water from adjacent tissue layer 27b, and so on, up to the water reservoir stored in superabsorbent layer 29, providing a “one-way” hydrating flow, and thus, a controlled release of water to the cut flowers.

In another preferred embodiment not shown, superabsorbent layer 29 is positioned between any two tissue layers 27 in absorbent body 26.

The absorbency of the absorbent material and/or superabsorbent material and/or superabsorbent layer 29 in absorbent body 26 is typically from about 10 grams to about 1000 grams for outer module 20, where “absorbency” means the weight of liquid that can be absorbed by the absorbent body in outer module 20. More preferably, the total absorbency of outer module 20 is from about 250 grams to about 600 grams. Still more preferably, the total absorbency of outer module 20 is from about 400 grams to about 600 grams, with an average absorbency of about 500 grams.

Outer module 20 can be characterized by its “water delivery capacity,” which is how much water that can be stored in absorbent body 26, and how much water is available for the cut flowers.

Absorbent pad 10 can have outer dimensions and be of a shape that accommodates the shapes and footprint of any box or container in which flowers might be transported. As noted above, absorbent body 26 is preferably slightly smaller than the overall outer dimensions of outer module 20, so that top layer 22 and bottom layer 24 can be more easily sealed around edges 25. In an exemplary embodiment, outer module 20 is about 12.25 (12¼″) inches in length by about 7.5 (7½″) inches in width, and has an absorbent body 26 therein that is 11.25 (11¼″) inches in length by about 6.5 inches (6½″) in width, leaving about 0.5 inches (0.5″) (1.3 cm) perimeter around all four edges 25 of outer module 20 for sealing. In another exemplary embodiment, outer module 20 has overall outer dimensions of six inches (6″) (15.2 cm) in length by about three and a half inches (3.5″) (8.9 cm) in width, with an absorbent body 26 therein that is about five inches (5″) (12.7 cm) in length by about two and a half inches (2.5″) (6.4 cm) in width, leaving about 0.5 inches (0.5″) (1.3 cm) perimeter around all four edges 25 of outer module 20 for sealing.

In a preferred embodiment, outer module 20 has an active agent that is an antimicrobial agent (or a mixture of antimicrobial agents) that prevents degradation of the flower by microorganisms, such as fungi that cause botrytis. The active agent is preferably disposed in and/or on absorbent body 26.

An example of an antimicrobial agent in outer module 20 is citric acid. However, any antimicrobial can be employed, including, but not limited to, organic acid (that include, but are not limited to, citric acid, sorbic acid, lactic acid, ascorbic acid, oxalic acid, tartaric acid, acetic acid, and any combinations thereof), inorganic acid (such as boric acid), quaternary ammonium compound, and any combinations of such antimicrobials. Boric acid (and its salts, such as sodium borate) is a preferred active agent because of its bacteriostatic and antimicrobial activity, its buffering capacity, and its long use as an antimicrobial preservative in cosmetic products and pharmaceuticals. Also, boric acid does not readily penetrate intact skin, and so is relatively safe to handle with normal precautions, such as gloves, protective clothing, and eye protection.

In another exemplary embodiment, the antimicrobial agent can be an atmosphere modification system including, but not limited to: CO₂ generating system, O₂ scavenging system, chlorine dioxide (ClO₂), botrytis-inhibiting agent such as sulfur dioxide (SO₂), ethylene scavenging system, and any combinations thereof.

The total amounts of the antimicrobial agent can be advantageously scaled to the total absorbency of outer module 20. For example, an embodiment of outer module 20 with absorbent body 26 (i.e., absorbent tissue layers 27 and superabsorbent layer 29) that can absorb about 50 grams of water can contain about 1.0 gram of citric acid, which is about 2.0 weight % (wt %) based on the nominal absorbency of the outer module, for consistent inhibition of bacterial growth. For a different embodiment having a nominal absorbency of about 40 grams, the amount of the antimicrobial in absorbent body 26 is about 0.83 grams total, which is about 2.1 wt % based on the nominal absorbency of the outer module.

An exemplary embodiment of a CO₂ generation system is an acid and a base, such as citric acid and sodium bicarbonate, respectively, that react with each other (when activated by water or other liquid) to generate CO₂ gas. The acid component of the CO₂ generation system can be an organic acid (that includes, but is not limited to, citric acid, sorbic acid, lactic acid, ascorbic acid, oxalic acid, tartaric acid, acetic acid, and any combinations thereof) and inorganic acid (such as boric acid). An example of a base that can be used as part of a CO₂ generation system includes, but is not limited to, carbonate such as sodium bicarbonate, calcium carbonate, magnesium carbonate, and any combinations thereof. The ratio and amounts of acid and base, as well as their physical placement in the pad architecture, can be varied to control the timing and amount of CO₂ released. In one exemplary embodiment, citric acid and sodium bicarbonate are present in absorbent body 26 in a ratio of about 4:6, which can be activated by moisture and/or other water to generate CO₂ gas. Citric acid provides an additional benefit by interacting with the sodium ion of sodium bicarbonate to create a citric acid/sodium citrate buffer system that helps maintain a pH that is compatible with preservation of flowers. Sodium citrate salt can also reduce water retention by superabsorbent layer 29, thereby releasing additional water from the superabsorbent layer into tissue layers 27 to be available to hydrate the cut flowers. Other acids can be selected for a CO₂ generation system, with amounts and ratios adjusted in accordance with the pKₐ of the acid.

Examples of an ethylene inhibitor or ethylene competitor agent includes, but is not limited to, 1-methylcyclopropene, (also called “MCP” or “1-MCP”), its salts and chemical derivatives. Another example of an ethylene inhibitor is a strong oxidizing agent, such as potassium permanganate (KMnO₄), which chemically reacts with ethylene to reduce the amount of free ethylene available to bind to ethylene receptors of the flowers. The one or more ethylene competitor agents can be selected to bind either reversibly or irreversibly to the ethylene receptors in the flowers.

An exemplary embodiment of the present treatment system has a combination of a CO₂ generation system and a compound that is an ethylene competitor, such as MCP. This combination has been observed to result in an increase in the lifespan of cut roses of approximately two days. This is surprising since it is believed that by interfering with the ethylene receptors, CO₂ would also prevent the ethylene competitor, MCP, from binding. However, since the ethylene competitor is developed in a burst over a short period of time and then dissipates, while CO₂ is generated over a longer period of time and its effects become significant after the ethylene competitor has finished or dissipated.

In another embodiment, the MCP precursors are distributed throughout the pad architecture in such a manner that the gas is generated in stages as the activation liquid travels though the layers of the pad. An outer module containing creped tissue fosters migration of liquids and/or moisture in both the horizontal and vertical axes of the outer module. As the liquid and/or moisture is distributed horizontally, the active chemicals or precursors on any given layer of the pad are activated. Vertical migration of liquids and/or moisture will carry one active component to another active component positioned on a different level of the pad architecture. In this way, the rate and duration of gas generation can be controlled and prolonged by the use of membranes that control vertical migration, the stoichiometry and amount of the active agents, and placement of active components in the different layers of the outer module.

Another exemplary embodiment of the present treatment system has a CO₂ generation system, without another active agent. CO₂ inhibits the effects of ethylene on cut flowers by changing the chemistry on the ethylene receptor site, and also dissolves into the moist part of cut flowers where it provides a bacteriostatic effect as well as interfering with ethylene binding. However, the CO₂ diffuses from the ethylene receptor over a period of several hours, and so the effects of CO₂ on inhibiting ethylene are reversible over time. For this reason, absorbent pad 10 exposes the flowers in the container to CO₂ over a period of time that is sufficient to enhance preservation throughout transport.

A further exemplary embodiment of the present treatment system has an SO₂ generation system and an ethylene competitor, such as MCP, in inner module 30. Another exemplary embodiment has a CO₂ generation system and an ethylene competitor, such as MCP, in outer modules 20 and/or 40.

In yet a further exemplary embodiment of the present treatment system, an ethylene competitor, such as MCP, is used in inner module 30 alone. In a still yet further embodiment, an ethylene competitor, such as MCP, is used in outer module 20, and/or outer module 40. Thus, one or more ethylene competitors can be present in any one of the outer modules or inner module either alone or with another active agent.

Yet a further exemplary embodiment, the present treatment system has a CO₂ generation system and a superabsorbent material, where the superabsorbent material operates as a reservoir for water that activates the CO₂ generation system and also as a source of water vapor (moisture) in the container to hydrate the cut flowers so the flowers do not dry out during transport. Examples of superabsorbent material include, but are not limited to, superabsorbent polymer such as polyacrylate (and its laminates with cellulose, airlaids or non-wovens). A preferred exemplary embodiment has a CO₂ generation system and a starch-based superabsorbent material, such as BioSAP™ (Archer-Daniels Midland, Decatur, Ill.), which is a renewable resource.

In yet another exemplary embodiment of the present treatment system, there is a compound that is an ethylene competitor contained in the outer module. The ethylene competitor can be, but is not limited to, MCP.

In still another exemplary embodiment of the present treatment system, there is a CO₂ generation system in combination with KMnO₄ in an outer module described below, where the components of the CO₂ generation system and KMnO₄ are held in separate pockets of the outer module prior to activation.

Examples of an oxygen scavenging system is any enzyme that includes, but is not limited to, glucose oxidase, catalase, lactase, oxidoreductase, invertase, amylase, maltase, dehydrogenase, hexose oxidase, oxygenase, peroxidase, cellulase, and any combinations thereof. Other examples of an oxygen scavenging system include an oxidizable metal, including, but not limited to, iron, zinc, copper, aluminum, tin, and any combinations thereof.

As noted above, another example of an antimicrobial agent that can prolong the life of cut flowers is chlorine dioxide (ClO₂), which can be generated in the container by one or more ClO₂ generating components. The container for the cut flowers can have a liner of coated paper having a chlorine dioxide (ClO₂) generating system coated thereon that is positioned on one or more of the container surfaces. Alternatively, the ClO₂ generating components can be present inside of outer module 20. Chlorine dioxide is an antimicrobial that reduces the effects of fungi (such as fungi that cause botrytis and its associated damage in flowers), and demonstrably changes the atmosphere in the container. However, the ClO₂ generating system needs to be kept physically separated from water until activation since it is water-activated. Also, concentrations of the components of the ClO₂ generating system have to be carefully regulated to prevent discoloration of the cut flowers. Thus, it is important that the concentrations of the components of the ClO₂ generating system are carefully regulated to prevent discoloration of the cut flowers.

An exemplary embodiment of an SO₂ generation system includes, but is not limited to, sodium metabisulfite (Na₂S₂O₅), which reacts with water and/or moisture to generate SO₂. Another embodiment of a SO₂ generation system employs sodium bisulfite (NaHSO₃).

Still other active agents that can be used in outer module 20 include one or more vitamins, sugar (as a source of carbohydrates), plant hormones, and other plant “foods” that nourish or treat the cut flower. For example, an embodiment of outer module 20 includes a sugar that is sucrose and/or glucose. Another embodiment of outer module 20 includes a plant hormone that is a cytokinin.

By pre-selecting the amount of an active agent, such as a vitamin, nutrient, or plant food in outer module 20, the grower, florist, or consumer only has to add water to the outer module, and the “right” amount of the treatment is provided to the cut flowers.

The one or more absorbent layers can be arranged to form separate pockets or compartments in the outer module. As used herein, a “pocket” means an area enclosed between two layers that can hold in place one or more active agents. Each active agent/active system can be positioned in a pocket in outer module 20, which pocket is formed by: any two tissue layers 27; any tissue layer 27 and superabsorbent layer 29; topmost tissue layer 27 and top layer 22; and/or bottommost tissue layer 27 and bottom layer 24. Alternatively, an active agent can be incorporated in and/or on superabsorbent layer 29. When the pocket is formed by two tissue layers or by a tissue layer and a superabsorbent layer, the pocket is independent of top layer 22 and bottom layer 24.

“Pad architecture” as used in this application means the structure and order of individual tissue layer(s) 27, superabsorbent layer 29, the top and bottom layers 22 and 24, respectively, and/or any active agents therein.

“Regulation” means controlling the speed, location and amount of liquid absorption, as well as controlling activation speed and duration of release of active agents.

Thus, varying the pad architecture can be used to regulate uptake of liquids exuded by a flower on outer module 20, and to regulate activation, rate of release, and duration of the active agent. A pad architecture that physically separates the individual chemical components of an active agent with tissue layers can be selected to delay activation and/or provide an “extended release” of the active agent contained in outer module 20. For example, positioning a larger number of tissue layers 27 above and/or below superabsorbent layer 29 can delay activation and extend release of an active agent in superabsorbent layer 29. In an exemplary embodiment shown in FIG. 7, positioning four tissue layers 27a, 27b, 27c, 27d above superabsorbent layer 29 can delay activation, and also serve as a reservoir for extended release or extended availability of water.

“Activation speed” as used in this application is the rate at which an active agent (or combination of reagents that, when contacted with each other, combine to form an active agent) is activated by contact with a liquid, such as water, to exert an effect on prolonging the life and/or appearance of cut flowers. Activation speed can be increased or reduced by careful selection of the number of tissue layers in the pad architecture, the thickness or density of each tissue layer, and/or the material(s) used to make the tissue layer.

Activation speed can be further controlled by adding one or more semi-permeable membranes in the architecture of the outer module. An example of a semi-permeable membrane is a nonwoven. The nonwoven can have a pore size that regulates the passage speed of absorbed water or other liquid through the pad architecture, typically vertically. The pore size can be sized by selecting the density and weight of the nonwoven, or other material for the semi-permeable membrane, since the interaction of fibers of nonwoven will form the pore. Nonwoven fibers are projected from a nozzle in random fashion to form a nonwoven. Where three or more fibers interact, such as a triangular form, a hole (“pore”) is formed. Using a greater density or weight of fibers generally leads to formation of a nonwoven having a smaller pore size. In an exemplary embodiment, using a nonwoven material of high density or high weight will form a nonwoven with a small pore size. Generally, there is a direct correlation between a pore size and the passage rate of the water or other absorbed liquid. For example, a nonwoven having a small pore size will cause a slower passage rate of water or other absorbed liquids therethrough. However, in addition to pore size, passage speed can be otherwise increased or slowed by addition of a surfactant.

In another exemplary embodiment, the semi-permeable membrane itself can contain an active agent. The pad architecture can contain one or more semi-permeable membranes therein to regulate the activation rate and controlled release, such as delayed release, extended release, or sustained release. For example, pad architecture can be selected to cause a “staged” release of active, whereby separate portions of the active are released in different time periods.

The one or more active agents, or even the individual components that make up a single type of active system (such as the individual chemical components of a CO₂ generation system), can be separated by absorbent tissue layers in the structure of the outer module, laminate, or other material with limited or specific permeability, such that there is an immediate release or “burst” of CO₂ in the container, and also an extended release or “delayed burst” of CO₂ at a later time, i.e., when a different pocket of CO₂ generating components is activated by contact with water. The separate bursts of CO₂ in the container help to preserve and extend the lifespan of cut flowers and thereby reduce wastage.

The present disclosure also provides a treatment system that uses absorbent pad 10 to regenerate a modified atmosphere in container 50 after the container has been opened and re-closed to add or remove flowers. This is achieved by having a pad architecture of outer module 20 or outer module 40 where one or more active agents are positioned in separate pockets or in different layers, allowing the unexpended active agents to be activated after re-closing the container. The active agent, such as a carbon dioxide (CO₂) generation system or a sulfur dioxide (SO₂) generation system, modifies the atmosphere in the container having the cut flowers during storage and transport. The active agents can reduce senescence caused by ethylene and/or reduce infection of the flower by microorganisms such as Botrytis to prolong life and enhance appearance of the cut flowers.

As used in this application, “scaling” means selecting the proper amounts of active agent in relation to the amount of absorbent material and the type of flower being packaged. Scaling is critical to the performance of outer module 20. Some flowers produce very little moisture or water that would be available to activate the active agent, while other flowers produce a large amount of moisture or water. For example, if outer module 20 has too many tissue layers 27 relative to the amount of absorbed water, there may be insufficient liquid to dissolve the active agent(s) for their activation. Conversely, too few tissue layers 27, combined with a large volume of absorbed water, can dilute or even “drown” the active agent, thereby impairing its effectiveness.

The amount of active agent in the pad architecture of outer module 20 of the present disclosure for a given container of flowers can also be tailored depending on several factors including, but not limited to: the total volume of the container; the amount of flowers in the container (i.e., how much volume the flowers occupy in relation to headspace); how much of the active agent is expected to be lost; and other physical factors, such as temperature and pressure. Likewise, as noted above, the pad architecture can be tailored to regulate the rate of release of the active agent. For example, using a pad architecture where portions of the active agent are physically separated can provide a sustained release of an active agent in the container.

The outer module of the present disclosure can be secured to the container by one or more securing device (not shown), or can be unattached to the container and simply placed therein, on the bottom of the container or among the flowers. The one or more securing device, where present, can be on the outer module, on the container, or a combination of both.

The pad architecture of outer module 20 has the benefit that absorbent body 26 (e.g., tissue layers 27) actively “draws in” the water, whereupon the water is retained in the tissue layers and superabsorbent layer 29, and then gradually released over time to hydrate the flowers and enhance their appearance. The drawing action of outer module 20 increases the extent by which the pad retains, and then gradually releases, the water to the flowers.

Absorbent pad 10 provides a treatment system to preserve cut flowers from the point of cutting in the field by the grower until the sale to a customer and even transport by the customer to his home. That is, absorbent pad 10, and a method of using absorbent pad 10, can be used during storage and transport from the grower to the distribution center, from the distribution center to the florist or retail store, and/or from the florist or retail store to the customer.

The present treatment system offers the benefit of reducing the amounts of the greenhouse gas CO₂ as compared with conventional approaches where entire warehouses are filled with CO₂. Absorbent pad 10 allows the individual containers of cut flowers to have a modified atmosphere of a desired level of CO₂, rather than the entire warehouse, greatly reducing the overall amounts of CO₂ needed to prolong life of a given number of cut flowers. Since CO₂ is marginally heavier than air, the present pad placed in the bottom of a container, when activated by wetting, fills the container with CO₂. Thus, the treatment systems and methods of the present disclosure can significantly reduce the amounts of CO₂ released into the atmosphere as compared with amounts released by conventional transport of cut flowers.

Pad architecture, stoichiometry of the reactants (including selection of which reagent is present in excess), permeability of the membrane, and choice of reactants can be customized to provide the amount and duration of release of CO₂ (and/or SO₂, and/or ClO₂, and/or an ethylene competitor), based on the species of cut flower.

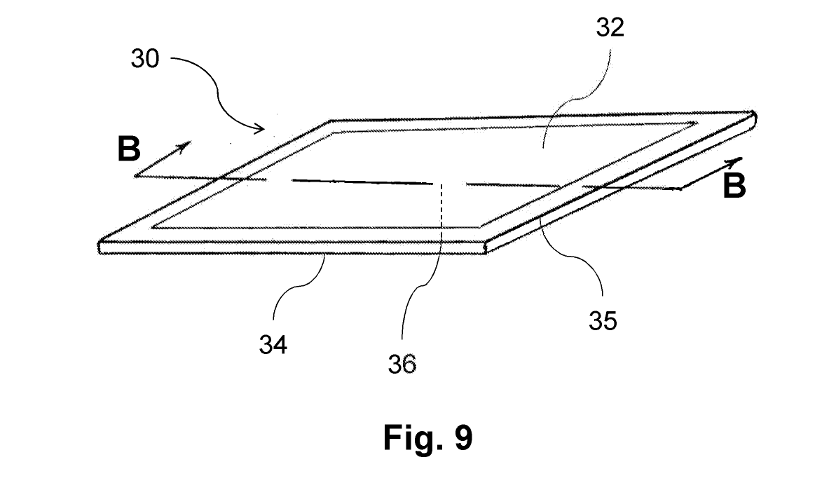

FIGS. 9 through 11 illustrate an exemplary embodiment of inner module 30 (SO₂ module) used in absorbent pad 10. Inner module 30 has a top layer 32, and a bottom layer 34 opposite top layer 32. Between top layer 32 and bottom layer 34 is an absorbent body 36 made of one or more layers of an absorbent and/or superabsorbent material. Top layer 32 and bottom layer 34 directly contact each other and are sealed at edges 35 to seal inner module 30, and to enclose absorbent body 36. A laminate 39 can optionally be part of inner module 30, and if present, is positioned between top layer 32 and bottom layer 34.

Top layer 32 is a film that is polyethylene, polypropylene, polyester, or any combinations thereof. In an exemplary embodiment, top layer 32 is a blown polyethylene film. The blown polyethylene film can have a thickness of about 0.65 mil. In another embodiment, top layer 32 is any nonwoven material. In yet another embodiment, top layer 32 is made of coffee filter tissue (CFT).

Bottom layer 34 is a nonwoven material that is a polyolefin, polyester, or polyamide. Examples of nonwovens films for bottom layer 34 include, but are not limited to, polyethylene, polypropylene, polyester, or any combinations thereof. In a preferred exemplary embodiment, bottom layer 34 is made of spunbonded polypropylene. In another preferred embodiment, bottom layer 34 is made of a perforated polyethylene or perforated polypropylene. Bottom layer 34 can also be a hydrophilic nonwoven material, or treated with a surfactant or other hydrophilic material, to permit liquid uptake into tissue layers 37 and laminate 39.

Alternatively, bottom layer 34 can be made of coffee filter tissue (CFT). The CFT can be made of a 16.5-pound white crepe paper that is about 99.5% softwood pulp, where “softwood pulp” means a pure virgin wood pulp that has never been processed. The softwood pulp can be bleached or unbleached. CFT can also contain about 0.5% of a wet-strength resin to give strength to the cellulosic fibers of the CFT when wet. An example of a wet-strength resin includes, but is not limited to, polyamide-epichlorohydrin (PAE) resin.

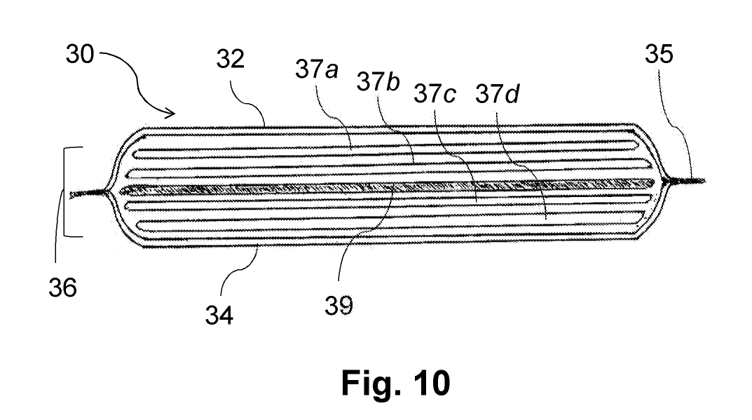

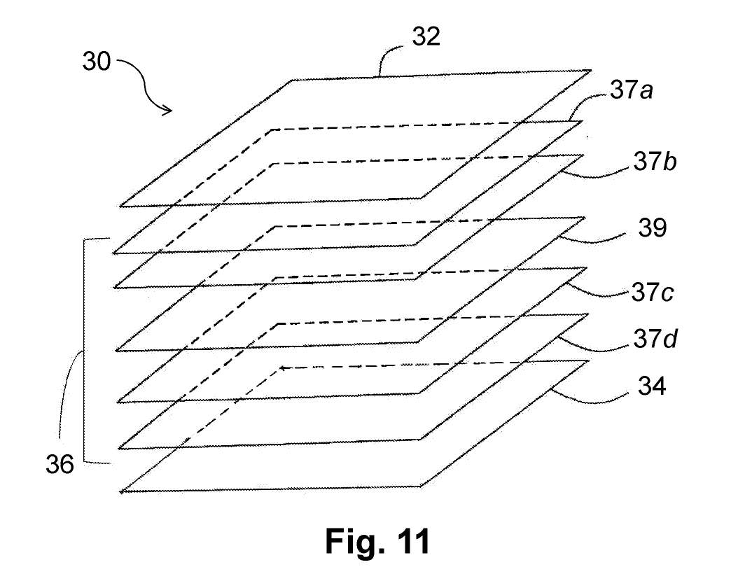

Absorbent body 36 is made of one or more layers of an absorbent material or a superabsorbent material. Absorbent body 36 absorbs liquids exuded from flower that is placed on inner module 30, and/or condensation in the container that forms while cooling the flower during storage or transport. Absorbent body 36 is preferably made of an absorbent material that is one or more layers of tissue 37, where tissue 37 means either one or all layers of tissue, each separate layer being shown in FIGS. 10 and 11 as tissue layers 37a to 37d. Each tissue layer 37 is made of a sheet of cellulose tissue, and can itself be formed of one or more individual tissues that are joined together to form the tissue layer. The number of tissue layers 37, as well their arrangement in the absorbent body 36 of inner module 30, can be varied to regulate the absorption for the absorbent pad, as well as to regulate activation of any active agents therein. Besides tissue, the absorbent material can also be fluff pulp, cellulosic material, binding fiber, airlaid, nonwoven, woven, polymer, absorbent gel, compressed composite with short or microfiber material, thermoplastic polymer fiber, cellulose powder, or any combinations thereof. Examples of a superabsorbent material includes, but are not limited to, polyacrylate or carboxymethyl starch (CMS), superabsorbent polymer (SAP), compressed SAP, composite of SAP granules adhered with binder or plasticizer, airlaid with SAP, or a starch-based superabsorbent material, such as BioSAP™ (Archer-Daniels Midland, Decatur, Ill.), which is biodegradable and compostable. The nonwoven material can be spunbonded polypropylene or perforated plastic films.

In an exemplary embodiment, the total absorbency of the absorbent material and/or superabsorbent material and/or laminate 39 in absorbent body 36 of inner module 30 is from about 10 grams to about 1000 grams, where “absorbency” means the weight of liquid that can be absorbed by absorbent body 36 of inner module 30. More preferably, total absorbency of inner module 30 is from about 250 grams to about 600 grams. Still more preferably, total absorbency of inner module 30 is from about 400 grams to about 600 grams, with an average absorbency of about 500 grams. In another exemplary embodiment, absorbent body 36 has a total absorbency from about 120 grams to about 200 grams. More preferably, total absorbency of inner module 30 is from about 145 grams to about 175 grams, and still more preferably, total absorbency of inner module 30 is about 160 grams.

As described above, absorbent body 36 is preferably smaller than the overall outer dimensions of inner module 30, so that top layer 32 and bottom layer 34 can be more easily sealed around edges 35. In an exemplary embodiment, inner module 30 is about 12.25 (12¼″) inches in length by about 7.5 (7½″) inches in width, and has an absorbent body 36 therein that is 11.25 (11¼″) inches in length by about 6.5 inches (6½″) in width, leaving about 0.5 inches (0.5″) (1.3 cm) perimeter around all four edges 35 of inner module 30 for sealing. In another exemplary embodiment, absorbent body 36 is about nineteen inches (19″) (48.3 cm) in length by about eleven inches (11″) (27.9 cm) in width, which can be used in inner module 30 having overall outer dimensions of twenty inches (20″) (50.8 cm) in length by about twelve inches (12″) (30.5 cm) in width, thereby leaving about 0.5 inches (0.5″) (1.3 cm) around all four edges 35 of inner module 30 for sealing.

Inner module 30 preferably includes a laminate 39 positioned between top layer 32 and bottom layer 34. When present, laminate 39 is preferably a part of absorbent body 36, along with tissue layers 37 and/or other absorbent material. Alternatively, laminate 39 can be the entirety of absorbent body 36. Laminate 39 is made of one or more plies of a cellulosic material, an adhesive (such as glue) or binder, and preferably includes an active agent. In an exemplary embodiment of inner module 30 of the present disclosure, laminate 39 is a mixture of cellulosic material and an SO₂ generation system (active agent) that contains sodium metabisulfite (Na₂S₂O₅) that, when activated with water, condensation, or by contact with liquid exuded by the flower, reacts to generate SO₂.

Laminate 39 offers several advantages for inner module 30. First, laminate 39 can incorporate large amounts of an active agent in a relatively thin structure, while avoiding the disadvantages of having large amounts of dry, loose chemicals that can cause the absorbent pad to “bulge” or have active agents that collect disproportionately in one portion of inner module 30 when the pad is picked up by one edge. Second, because an active agent can be uniformly distributed in laminate 39, selecting a prescribed length and number of plies of laminate 39 permits the total amount of active agent to be determined with certainty. An exemplary embodiment of laminate 39 is a cellulosic material and an SO₂ generation system (e.g., Na₂S₂O₅) that is uniformly distributed therein to form one or more plies of laminate 39. Inner module 30 can have about 1 gram to about 20 grams of an SO₂ generation system, which is preferably Na₂S₂O₅ that is uniformly distributed in the plies of laminate 39. More preferably, inner module 30 has about 5 grams to about 9 grams of an active system, such as an SO₂ generation system. Still more preferably, inner module 30 contains about 7 grams of an active system, such as an SO₂ generation system. The specific amounts of the active agent/active system and its position in relation to the absorbent material can be selected depending on the size of inner module 30 and the type and quantity of flower that is being preserved. An advantage of incorporating large amounts of active agent in laminate 39 is the large reservoir of active agent that is available for “extended release” of the active agent over time.

Inner module 30 can have active agent/active system (for example, an SO₂ generation system in the absorbent pad as Na₂S₂O₅ that will react with water or moisture to form SO₂) that is present in inner module 30 in an amount that is between 0.01 grams per square inch (gsi) to about 0.10 gsi. More preferably, the active agent or active system is present in inner module 30 in an amount from about 0.02 to about 0.45 gsi, and still more preferably, the active agent is present in inner module 30 in an amount of about 0.038 gsi.

In a preferred embodiment, absorbent body 36 has an active agent that is a sulfur dioxide (SO₂) generating system to minimize or prevent botrytis and other damage to a flower caused by microorganisms. However, other active agents, such as an ethylene scavenger, CO₂ generating system, chlorine dioxide (ClO₂), O₂ scavenger, or any combinations thereof, can be used with, or instead of, the SO₂ generating system. An exemplary embodiment of a CO₂ generation system is an acid and a base, such as citric acid and sodium bicarbonate, respectively, that react with each other (when activated by water or other liquid) to generate CO₂ gas. The acid component of the CO₂ generation system can be a flower-safe organic acid or an inorganic acid. The ratio and amounts of acid and base, as well as their physical placement in the pad architecture, can be varied to control the timing and amount of CO₂ released. In one exemplary embodiment, citric acid and sodium bicarbonate are present in absorbent body 36 in a ratio of about 4:6, which can be activated by moisture and/or other flower exudates to generate CO₂ gas. Citric acid provides an additional benefit by interacting with the sodium ion of sodium bicarbonate to create a citric acid/sodium citrate buffer system that helps maintain a pH that is flower-compatible. Other acids can be selected for a CO₂ generation system, with amounts and ratios adjusted in accordance with the pKₐ of the acid. Another example of an active agent in absorbent body 36 is an antimicrobial agent. Examples of an ethylene inhibitor or ethylene competitor agents include, but are not limited to, 1-methylcyclopropene, (also called “MCP” or “1-MCP”), or its salts or chemical derivatives. The one or more ethylene competitor agents can be selected to bind either reversibly or irreversibly to the ethylene receptors. Examples of an oxygen scavenging system include, but are not limited to, an enzyme such as glucose oxidase, catalase, oxidoreductase, invertase, amylase, maltase, dehydrogenase, hexose oxidase, oxygenase, peroxidase, cellulase, or any combinations thereof. Other examples of an oxygen scavenging system include an oxidizable metal, including but not limited to, iron, zinc, copper, aluminum, tin, or any combinations thereof. Examples of an antimicrobial agent include organic acid (such as citric acid, sorbic acid, lactic acid, or any combinations thereof), quaternary ammonium compound, inorganic acid, or any combinations thereof.

Each active agent/active system can be positioned in a pocket in inner module 30 which pocket is formed by: any two tissue layers 37; any tissue layer 37 and laminate 39; topmost tissue layer 37 and top layer 32; and/or bottommost tissue layer 37 and bottom layer 34. Alternatively, an active agent can be incorporated in one or more plies of laminate 39. When the pocket is formed by two tissue layers or by a tissue layer and a superabsorbent layer, the pocket is independent of top layer 32 and bottom layer 34.

In addition, inner module 30 provides individualized treatment for each of the containers of flowers, without requiring large-scale generation of SO₂ that may be produced by some conventional methods that simply use a bucket of a SO₂ precursor in an enclosed room to generate SO₂ in the room. The present method of using inner module 30 reduces the likelihood of SO₂ toxicity or allergies for workers caused by exposure to very high concentrations of SO₂ produced in an enclosed room by some conventional methods.

Optionally, to obtain a higher concentration of the active gas in the crates, a large barrier material, such as plastic, can be placed over the containers of flowers by creating, in effect, a miniature closed system. However, inner module 30 is generally so effective for treatment for the prevention of botrytis and other infections, since absorbent pad 10 is placed in each individual crate, that the use of a barrier material is not necessary to enhance freshness and prolong the life of flowers.

As noted above, inner module 30 is sealed around its periphery at edges 35. In an exemplary embodiment, the sealed portion is about a half-inch (0.5″) (1.3 cm) around each edge 35. However, the amount of edge 35 that is sealed can vary in size to be more or less than 0.5″ (1.3 cm).

Referring to the exemplary embodiment of inner module 30 shown in FIGS. 9 through 11, top layer 32 is polyethylene film, and bottom layer 34 is spunbond polypropylene nonwoven. Absorbent body 36 has four tissue layers 37a to 37d. Tissue layer 37a is adjacent to top layer 32. Another tissue layer 37d that is adjacent to bottom layer 34. Laminate 39 is a cellulosic material, such as crepe tissue, and contains an SO₂ generation system (e.g., Na₂S₂O₅), and glue to hold the laminate together. Tissue layers 37b and 37c are directly above and directly below laminate 39, respectively.

Absorbent pad 10 preferably covers the entire footprint of the container in which the flowers are stored and transported to provide effective treatment of the flower over time, where “footprint” means the surface area of the bottom of the crate. However, absorbent pad 10 can cover less than the entire footprint and still provide concentrations of the active agent that effectively treat the flowers to achieve the desired results. In a preferred embodiment, absorbent pad 10 covers between about 60% to about 100% of the footprint. An absorbent pad 10 that covers at least 50% of the footprint of the crate still provides relatively effective treatment of flowers. Conversely, absorbent pad 10 can be larger than the footprint of the crate (i.e., greater than 100% of the footprint of the crate). The excess portions of absorbent pad 10 can be folded up one or more sides of container 50.

Absorbent pad 10 is placed in each separate container 50 in which the flowers are packaged, so that each container receives its own source of SO₂ (or other active) from inner module 30.

Examples of flowers that can be packaged with absorbent pads 10 disclosed herein include, but are not limited to, rose, peony, geranium, carnation, Alstroemeria, lily, Dianthus, Gypsophila, chrysanthemum (mums/pom poms), tulips, hydrangea, Calla, Aster, and Limonium/statice. Smaller flowers have a large surface area that can absorb gases in a container, and so would benefit from absorbent pad 10, which can replenish an active agent, such as SO₂, inside the container over an extended time of storage and transport.

The amount of SO₂ generated by the inner module 30 can be controlled based on the amount of its chemical precursor(s), such as Na₂S₂O₅, and access of the chemical precursor to moisture in the air, and/or contact with liquid exuded from the flower.

Absorbent pad 10, by providing a controlled release, and thus a replenishable source of atmosphere modifying gases inside container 50, allows the flower grower and processor (at the start of the supply chain) to exert more control over the lifespan and physical and sensory characteristics of the flowers long after the container has left the grower's dock and are in transit. This represents a significant benefit to the flower grower and processor.

A “container” (also called “shipping container”) as used in this application is any enclosed, controlled environment for packaging cut flowers that prevents passage of normal atmospheric air to the cut flowers therein, yet provides access to the cut flowers so that flowers can be placed in, or taken therefrom. Examples of a container include, but are not limited to, a cardboard box, a metal or plastic container having a cover, a sealable bag, and a closeable cooler, including those containers that briefly store the flowers (but are not used in transport). The container is often not airtight and remains permeable to ambient air and humidity even after the flowers are placed inside and the container is closed for shipping. However, the absorbent pad of the present disclosure can be used in containers of flowers that are airtight. An exemplary embodiment of a container 50 for flowers is a cardboard box having dimensions that are about 20 inches (20″) (50.8 cm) to about 60 inches (60″) (152.4 cm) in length by about 10 inches (10″) (25.4 cm) to about 20 inches (20″) (50.8 cm) in length by about 4 inches (4″) (10.2 cm) to about 16 inches (16″) (40.6 cm) in height. In another exemplary embodiment, the container is 4 feet (4′) (121.9 cm) to about five feet (5′) (152.4 cm) in length by about one foot (1′) (30.5 cm) in width by about 4 inches (4″) (10.2 cm) to ten inches (10″) (25.4 cm) in height. A preferred size of container 50 is a cardboard box that is 41″ (104.1 cm) in length by 10″ (25.4 cm) in width by 8″ (20.3 cm) in height. Approximately 100 to 200 cut roses can be placed in a container having these dimensions.

The absorbent pad of the present disclosure is operable below 32° F. (0° C.). However, flowers are generally not transported below the freezing temperature of water because of unfavorable effects on flower appearance. As noted above, cut flowers are often shipped in chilled temperatures between 34° F.-40° F. (1.1° C.-4.4° C.) to decrease respiration of the flowers, and preserve their lifespan, physical appearance, and sensory attractiveness (e.g., floral “smell”).

Absorbent pad 10 of the present disclosure enhances the physical appearance and sensory characteristics of a cut flower, which include, but are not limited to: visual appearance, color, robustness, smell, freshness, and “vase life” of the flower. Absorbent pad 10 also slows deterioration of flowers during transport.

A method of using absorbent pad 10 having three or more modules is also disclosed. The method includes the steps of placing absorbent pad 10 in and at the bottom of a container 50 of flowers before closing the container. Alternatively, absorbent pad 10 can be wrapped around part or all of the flowers before placing the flowers in the container. Pre-wetting the outer modules, such as 20 and 40 of FIG. 1, of absorbent pad 10 can be by spraying water, by a specialized machine designed to wet only the outer modules. Activation of the active agents in the outer modules and inner module prolong the life of flowers during transport, and enhance the physical appearance and sensory characteristics of the cut flowers for a longer time as compared with conventional transport of flowers.

### EXPERIMENTAL

### Tests Performed

Amounts and concentrations of SO₂ that were generated under different conditions were tested as described below.

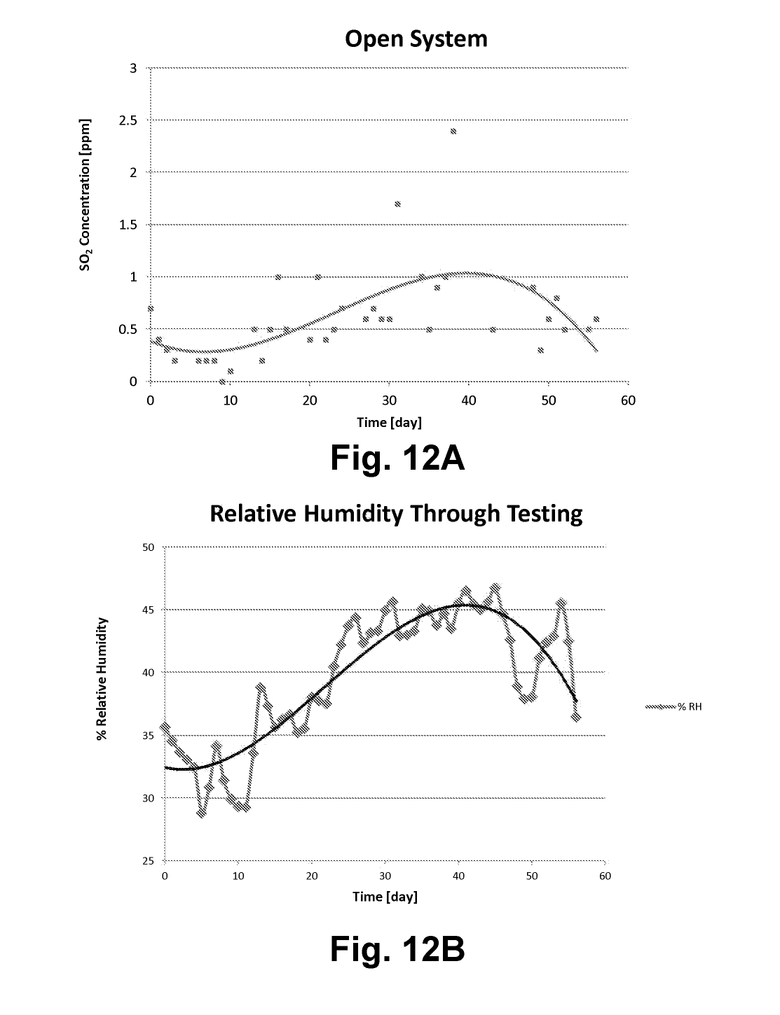

FIG. 12A and FIG. 12B show the results of a test that was performed to establish how Na₂S₂O₅ reacts with the environment, and the effect of changes in relative humidity.

0.1 g of Na₂S₂O₅ on sampling “boats” were placed on top of a counter; i.e., in an “open” environment. The concentration of SO₂ gas (in parts per million, ppm) in the air at about 2.5 cm (about 1″) above the Na₂S₂O₅ was measured daily for more than 50 days of testing. The relative humidity was also measured for each day of testing.

FIG. 12A shows a graph of SO₂ concentration (ppm) and the number of days of testing. The data indicate that 0.1 grams of Na₂S₂O₅ in an open environment generated an average of 0.5 ppm of SO₂ for up to 50 days.

FIG. 12B shows the relative humidity for each day during the trial, shown as % Relative Humidity and days of testing. The data indicate an apparent correlation between the relative humidity and the amount of SO₂ gas generated. This is in agreement with the known chemistry of Na₂S₂O₅.

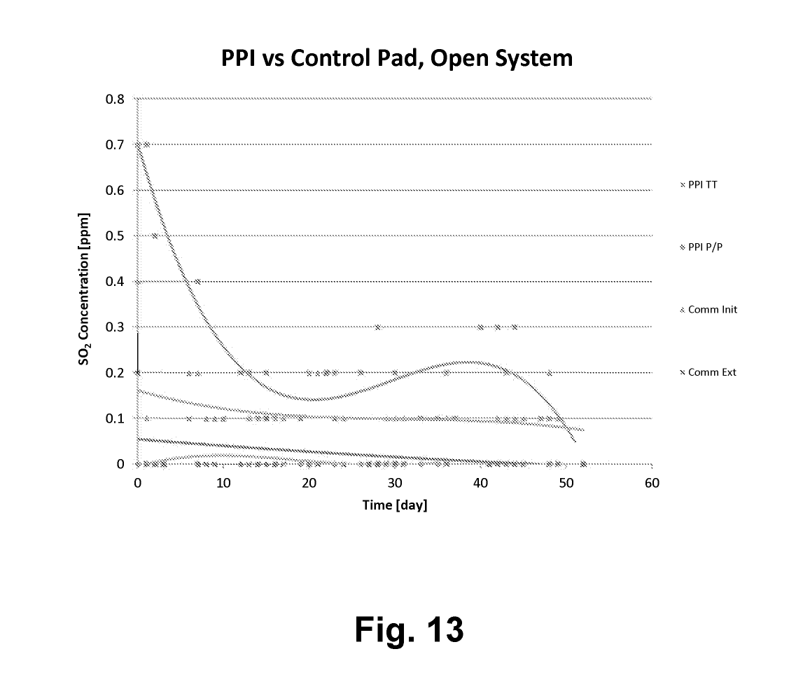

FIG. 13 shows the results of an “open system” test, in which the SO₂ gas generation of two absorbent pads (labeled as “PPI-TT” and “PPI-P/P,” respectively) having different structures and different amounts of Na₂S₂O₅, were compared against a control pad having two pockets that generate SO₂ gas. The “open system” test means that the SO₂ gas generated by the absorbent pads was vented.

The “PPI-TT” pad in FIG. 13 has a top layer and a bottom layer that are both made of Coffee Filter Tissue (CFT), and the pad contained 0.05 of Na₂S₂O₅. The “PPI-P/P” pad has a top layer and a bottom layer that are both made of polyethylene, and the pad contained 0.25 g of Na₂S₂O₅.

The control pad in FIG. 13 has two pockets, the first pocket containing 0.05 g of Na₂S₂O₅ to provide an “initial burst” of SO₂ and the second pocket containing 0.25 g of Na₂S₂O₅ to provide an “extended release” of SO₂. The two pockets of the control pad were taken apart and tested separately for gas generation, and labeled “Comm hit” and “Comm Ext”, respectively, in FIG. 13.

The pads were placed in an open environment to mimic the actual conditions of use. SO₂ concentrations were measured for more than 50 days, and the SO₂ concentrations over the number of days of testing.

FIG. 13 shows that both the PPI P/P pad and the extended release pocket of the control pad (“Comm Ext”) released very low levels of SO₂. The initial burst pocket and the PPI-TT pad released an average of 0.1 ppm of SO₂ into the surrounding atmosphere. It was observed that the PPI-TT pad released a burst of gas at the beginning of the cycle and then, after 15 days, reached a similar equilibrium point as the initial release portion of the control pad (“Comm hit”) at about 0.2 ppm of SO₂.

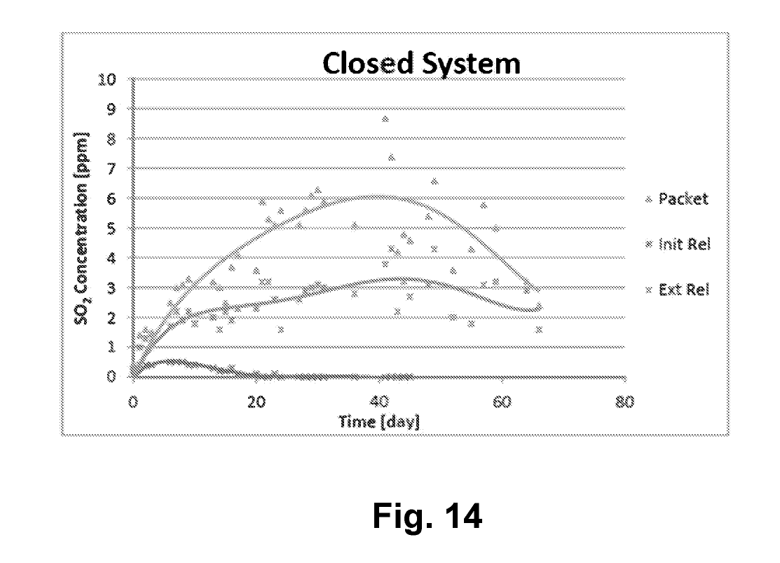

FIG. 14 shows the results of a “closed system” test. In this test, a control pad was taken apart and the amounts of SO₂ generated by the individual pockets (called the “initial burst” pocket and “extended release” pocket, respectively) were measured against the SO₂ generated by a full cell (i.e., both pockets together). The “initial burst” pocket contained about 0.05 grams of Na₂S₂O₅ and the “extended release” pocket contained about 0.25 g of Na₂S₂O₅. The full cell contained about 0.3 g of Na₂S₂O₅, which is the sum of the two individual pockets. The “full cell” refers to only one cell of the full pad; the full pad would contain approximately 7 g of Na₂S₂O₅. Each of the three samples was placed in a sealed tray to directly measure the amount of SO₂ generated. This allowed the amount of SO₂ generated to be measured without losses due to environmental influences (for instance, air movement).

FIG. 14 shows the results of SO₂ concentration (ppm) measured over more than 60 days. The data indicate that the total amount of SO₂ gas generated roughly correlates to the amounts of SO₂ generated by each of the individual components. No initial burst of SO₂ was observed.

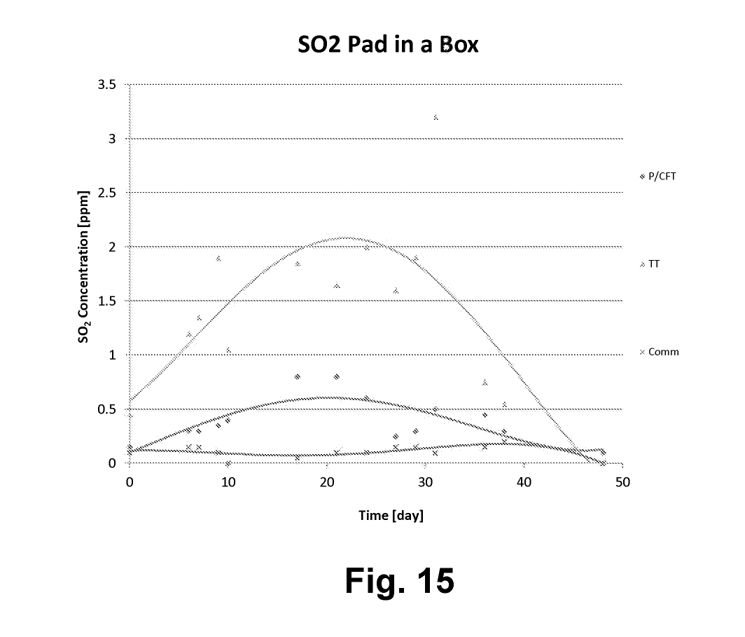

FIG. 15 shows the results of a “Flower Pad in a Box” test. In this test, three different pads were placed inside a container having about the same dimensions as a typical flower box. The containers had a loose flap that was used to simulate the relatively closed environment of the flower boxes, and that allowed gas measurements to be taken. The pads were labeled: “P/CFT” (i.e., polyethylene top layer, Coffee Filter Tissue bottom layer); “TT” (CFT top layer and CFT bottom layer), and “Comm” (a control pad having two pockets, described above).

One half-pad of each type containing 3.5 g of Na₂S₂O₅ was placed inside the container to simulate actual conditions for storage and transport of flowers. Measurements were taken by placing the SO₂ probe in the middle of the container.

FIG. 15 shows the results of this comparison of SO₂ concentration (ppm) over more than 40 days of measurements. The results show that the P/CFT pad is able to produce about the same amount of SO₂ gas (with a slightly higher yield) as the control pad. The CFT/CFT pad releases larger amounts of SO₂ gas than either of the other two pads tested.

Based on the several tests above, the results indicate that Na₂S₂O₅ has the capability to generate a continuous stream of SO₂ for more than 50 days. In fact, several tests showed SO₂ gas generation continues past the 60-day mark.

The gas generation chart shows a direct correlation of SO₂ generation and Relative Humidity in the atmosphere.

The total amount of SO₂ gas generated by a two-pocket control pad appears to be the sum of SO₂ gas generated by each of the pockets. The control pad does not appear to provide an initial burst of SO₂.

The pad made with a CFT top layer and CFT bottom layer (TT) shows an initial higher level of SO₂ generated, and then levels off at about 0.2 ppm of SO₂. This is somewhat higher than the levels generated by the control pad (about 0.1 ppm of SO₂). The pad having a polyethylene top layer and polyethylene bottom layer showed a lower total amount of SO₂ gas generated across the time period evaluated.

As used in this application, the word “about” for dimensions, weights, and other measures means a range that is ±10% of the stated value, more preferably ±5% of the stated value, and most preferably ±1% of the stated value, including all subranges therebetween.

It should be understood that the foregoing description is only illustrative of the present disclosure. Various alternatives and modifications can be devised by those skilled in the art without departing from the present disclosure. Accordingly, the present disclosure is intended to embrace all such alternatives, modifications, and variances that fall within the scope hereof.

What is claimed is:

1. An absorbent pad that prolongs the life of a cut flower in a container used for transport or storage of the cut flower, the absorbent pad comprising:
at least three adjacent modules, the at least three adjacent modules including a first outer module, a second outer module and an inner module positioned between the first outer module and the second outer module, wherein each of the first outer module, the second outer module and the inner module includes:
a top layer;
a bottom layer; and
an absorbent body made of one or more layers of absorbent or superabsorbent material, the absorbent body being positioned between and enclosed in the top layer and the bottom layer;
a first active agent in the absorbent body of the first outer module;
a second active agent in the absorbent body of the second outer module; and
a third active agent in the absorbent body of the inner module, wherein the first active agent, the second active agent and the third active agent are physically separate from each other.

2. The absorbent pad according to claim 1, wherein the first outer module is the same as the second outer module, and wherein the first active agent and the second active agent are the same active agent.

3. The absorbent pad according to claim 1, wherein the first active agent and the second active agent are each a carbon dioxide (CO₂) generating system.

4. The absorbent pad according to claim 1, wherein the third active agent is an active agent that minimizes or prevents botrytis caused by microorganisms to the cut flower.

5. The absorbent pad according to claim 1, wherein the third active agent is a sulfur dioxide (SO₂) generating system.

6. The absorbent pad according to claim 1 wherein the first active agent, the second active agent and the third active agent are each selected from the group consisting of: a sulfur dioxide (SO₂) generating system, a carbon dioxide (CO₂) generating system, an ethylene scavenger, an ethylene competitor agent, an ethylene inhibitor, 1-methylcyclopropene (MCP), chlorine dioxide (ClO₂), an oxygen scavenger, an antimicrobial agent, a botrytis-inhibiting agent, or any combinations thereof.

7. The absorbent pad according to claim 1, wherein the first outer module, the second outer module and the inner module are connected horizontally.

8. The absorbent pad according to claim 1, wherein each of the first outer module, the second outer module and the inner module are inside of an outer chassis.

9. The absorbent pad according to claim 1, wherein the number of modules in the absorbent pad is greater than three and is an odd number of modules.

10. The absorbent pad according to claim 1, wherein the inner module and the first and second outer modules are connected together.

11. The absorbent pad according to claim 1, wherein at least one of the first outer module and the second outer module includes a superabsorbent layer positioned between the top layer and the bottom layer.

12. The absorbent pad according to claim 1, wherein at least one of the first outer module and the second outer module includes a laminate positioned between the top layer and the bottom layer.

13. The absorbent pad according to claim 12, wherein at least one of the first active agent and the second active agent is in the laminate.

14. The absorbent pad according to claim 1, wherein the inner module includes a laminate positioned between the top layer and the bottom layer of the inner module.

15. The absorbent pad according to claim 14, wherein the third active agent is in the laminate.

16. The absorbent pad according to claim 14, wherein the absorbent body of the inner module is made of one or more tissue layers, and wherein the third active agent is in a pocket in the inner module.

17. The absorbent pad of claim 16, wherein the pocket is a structure formed from the group consisting of:
two tissue layers;
the laminate and a tissue layer;
the top layer and a tissue layer; and
the bottom layer and a tissue layer.

18. The absorbent pad of claim 1, wherein the first active agent has an antimicrobial agent.

19. An absorbent pad comprising three or more modules connected sequentially as a treatment system that modifies the atmosphere in a container to prolong life and enhance the physical/sensory characteristics of cut flowers in the container at all stages of storage and transport.

20. A method for prolonging the life and physical appearance of one or more cut flowers in a container, comprising:
placing an absorbent pad in the container, the absorbent pad comprising:
three or more adjacent modules including a first outer module, a second outer module and an inner module positioned between the first outer module and the second outer module, wherein each of the first outer module, the second outer module and the inner module includes:
a top layer;
a bottom layer; and
an absorbent body made of one or more layers of absorbent or superabsorbent material, the absorbent body being positioned between and enclosed in the top layer and the bottom layer;
a first active agent being in the first outer module;
a second active agent being in the second outer module; and
a third active agent being in inner module, wherein the first active agent, the second active agent and the third active agent are separated from each other,
placing one or more cut flowers on the absorbent pad so that at least one of the first outer module and the second outer module is positioned directly beneath petals of the one or more cut flowers in the container;
closing the container to enclose the one or more cut flowers; and
wetting at least one of the first outer module and the second outer module by spraying water thereon prior to closing the container.
